(19) United States
(12) Patent Application Publication
(10) Pub. No.: US 2021/0107635 A1
(43) Pub. Date: Apr. 15, 2021

(54) MULTI-ROTOR HELICOPTER AND COOLING METHOD IN MULTI-ROTOR HELICOPTER

(71) Applicant: NEC CORPORATION, Tokyo (JP)

(72) Inventors: Hisashi MIZUMOTO, Tokyo (JP); Toshiaki YAMASHITA, Tokyo (JP); Hideo ADACHI, Tokyo (JP)

(73) Assignee: NEC CORPORATION, Tokyo (JP)

(21) Appl. No.: 16/984,678

(22) Filed: Aug. 4, 2020

(30) Foreign Application Priority Data
Sep. 30, 2019 (JP) 2019-179790

(51) Int. Cl. B64C 27/08; B64D 27/24; B64D 31/00; B64D 33/08

(52) U.S. Cl. CPC B64C 27/08; B64D 33/08; B64D 31/00; B64D 27/24

(57) ABSTRACT

The multi-rotor helicopter includes an airframe that is a device main body, and a plurality of fan units configured to raise the airframe. Each of the plurality of fan units has a fan frame supported by the airframe, a propeller axially supported by a support arm integrated with the fan frame and configured to generate a lifting power and a propulsion power, a drive motor driven to rotate the propeller, and a motor driver configured to control a driving current supplied to the drive motor and control rotation of the propeller. The motor driver is provided at a position above the propeller.

This application is based upon and claims the benefit of priority from Japanese patent application No. 2019-179790, filed Sep. 30, 2019, the disclose of which is incorporated herein in its entirety by reference.

### TECHNICAL FIELD

The present invention relates to a multi-rotor helicopter that is capable of transporting objects, people, or the like, by air, and a cooling method in the multi-rotor helicopter.

### BACKGROUND ART

In recent years, various relatively small payload drone types of multi-rotor helicopter capable of transportation by air using a lifting power obtained by rotating propellers (rotor blades) of a rotor have been developed.

Since a multi-rotor helicopter has four, six or eight ducted rotors, control of a direction of flight and control of yawing, rolling and pitching are generally performed by controlling the propellers that constitute the ducted rotors.

In addition, as a technology related to a flight vehicle appropriate for large payload transportation such as of people, commodities, or the like, a personal flight vehicle (a personal aircraft) disclosed in U.S. Pat. No. 9,764,833 (hereinafter Patent Document 1) has been proposed. The personal flight vehicle includes a plurality of support booms coupled to blades of a flight vehicle main body, a plurality of rotors, and a controller. The plurality of rotors are disposed on upper end portions of the support booms and driven to rotate the propellers that are rotor blades. The controller is disposed at a center below the support booms and controls rotation of the propellers of the rotors.

In the support booms, ducts configured to guide some of air flows of the propellers to the controller at the center below the support booms are provided.

In such a flight vehicle, a heat quantity from a motor driver that is a controller configured to supply a large current to drive the propellers and maintain a posture of the airframe is high. For this reason, efficient exhaust heat measures are required in the motor driver.

In the above-mentioned personal flight vehicle, the air flow generated by the propellers is taken in from an air flow suction port disposed on an upper section of the support boom, and then, guided to the controller through a duct. After that, the air flow is discharged from an air flow discharge port disposed on a lower section of the support boom after cooling the controller.

### SUMMARY

The present invention is directed to providing a multi-rotor helicopter and a cooling method of a motor driver in a multi-rotor helicopter that is capable of efficiently cooling a controller using a simple configuration.

In order to solve the problems, the present invention proposes the following means.

A multi-rotor helicopter according to a first aspect of the present invention includes an airframe that is a device main body, and a plurality of fan units configured to raise the airframe, wherein each of the plurality of fan units has a fan frame supported by the airframe, a propeller axially supported by a support arm integrated with the fan frame and configured to generate a lifting power and a propulsion power by rotation, a drive motor driven to rotate the propeller, and a motor driver configured to control a driving current supplied to the drive motor and control rotation of the propeller, and the propeller of the fan unit is provided at a position below the motor driver.

In a cooling method of a multi-rotor helicopter according to a second aspect of the present invention, in a flight vehicle including an airframe that is a device main body, and a plurality of fan units configured to raise the airframe, wherein each of the plurality of fan units has a fan frame supported by the airframe, a propeller supported by a support arm integrated with the fan frame and configured to generate a lifting power and a propulsion power by rotation, a drive motor driven to rotate the propeller, and a motor driver configured to control a driving current supplied to the drive motor and control rotation of the propeller, the method includes: providing the support arm at a position above the propeller that becomes a suction side of the propeller, and supporting the motor driver using the support arm at the position thereabove.

### BRIEF DESCRIPTION OF THE DRAWINGS

FIG. 1 is a schematic view of a multi-rotor helicopter according to an embodiment.

FIG. 2 is an external view showing the multi-rotor helicopter of the embodiment from a side thereof.

FIG. 3 is an external view of FIG. 2 seen from above.

FIG. 4 is an enlarged external view in the vicinity of a guide plate of a support arm of FIG. 3.

FIG. 5 is a partial cross-sectional view of a rain shelter in Variant 2.

FIG. 6A is a first plan view showing an angle adjustment operation of a guide plate in Variant 3.

FIG. 6B is a second plan view showing the angle adjustment operation of the guide plate in Variant 3.

### EXAMPLE EMBODIMENT

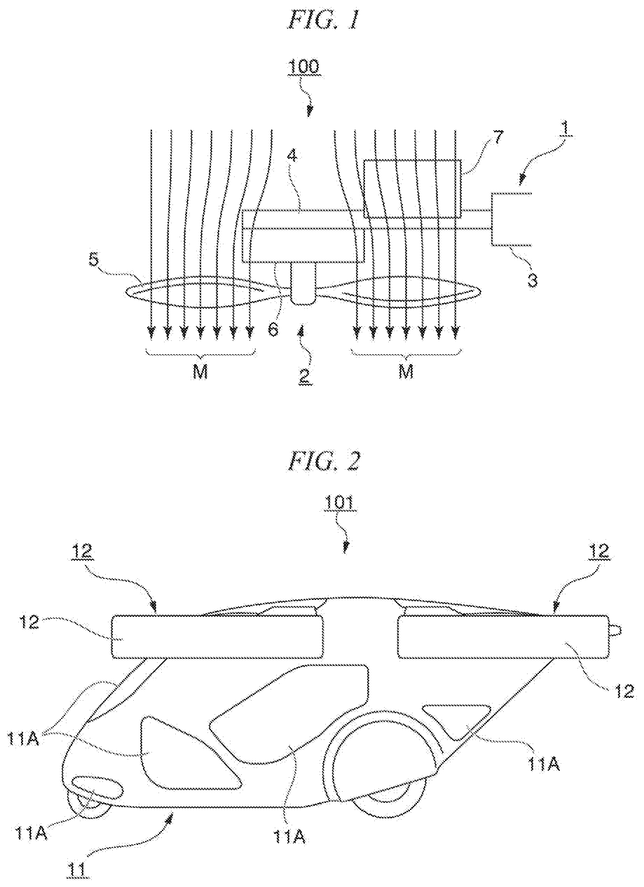

A multi-rotor helicopter (hereinafter, simply referred to as a flight vehicle) 100 according to an embodiment will be described with reference to FIG. 1.

The flight vehicle 100 includes an airframe 1 that is a device main body, and a plurality of fan units 2 (in FIG. 1, only one is shown) configured to raise the airframe 1, as main components.

Each of the fan units 2 has a fan frame 3 supported by the airframe 1, a propeller 5, a drive motor 6, and a motor driver 7. The propeller 5 is axially supported by a support arm 4 integrated with the fan frame 3 and generates a lifting power and a propulsion power by rotation. The drive motor 6 is driven to rotate the propeller 5. The motor driver 7 controls a driving current supplied to the drive motor 6 and adjusts rotation of the propeller 5.

The propeller 5 of the fan unit 2 is disposed at a position below the motor driver 7.

Then, in the flight vehicle 100 configured as above, the support arm 4 is provided integrally with the fan frame 3 of the fan unit 2 supported by the airframe 1, and the support arm 4 is disposed at a position above the propeller 5. In the flight vehicle 100, the motor driver 7 with a large heat quantity is further placed in the support arm 4 disposed at a position above the propeller 5.

Accordingly, in the flight vehicle 100, when the air is sent downward from above by rotational driving of the propeller 5 (an air flow is shown by an arrow M), the air suctioned into the propeller 5 from above comes in contact with the motor driver 7 on the support arm 4. Accordingly, the motor driver 7 can be cooled.

As a result, in the flight vehicle 100, it is possible to reduce the weight without requiring a dedicated cooling device by cooling the motor driver 7 using the air flow upstream from the propeller 5 that produces airframe thrust. The flight vehicle 100 cools the motor driver 7 disposed above the propeller 5 using the air flow from above by the propeller 5.

That is, in the flight vehicle 100 of the embodiment, the motor driver 7 can be efficiently cooled by a simple configuration in which the motor driver 7 with a large heat quantity is disposed on the support arm 4 that is disposed at an upper position that is a suction side of the propeller 5.

### Embodiment

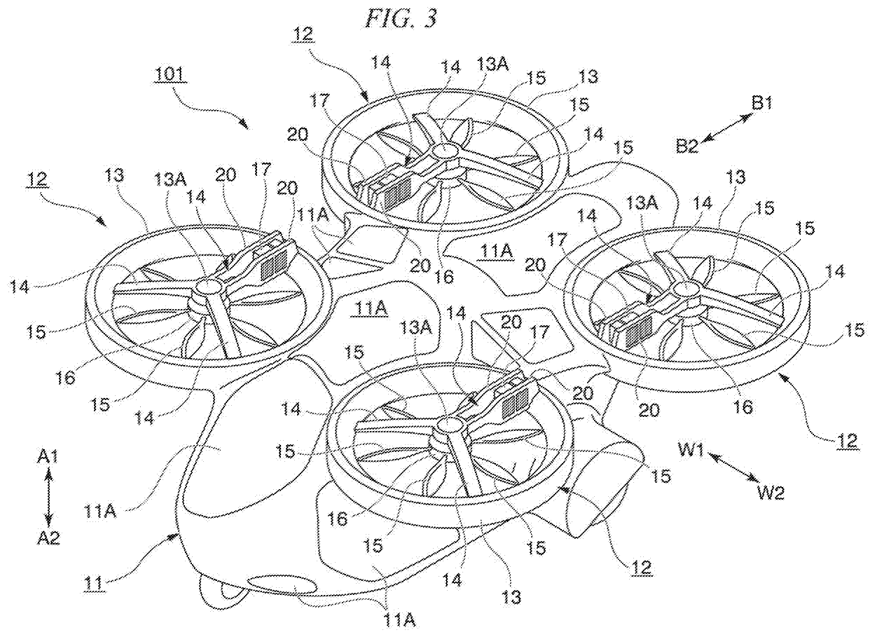

A flight vehicle 101 according to the embodiment will be described in detail with reference to FIG. 2 to FIG. 4. The flight vehicle 101 has, as shown in FIG. 2 and FIG. 3, the airframe 11 that is a device main body, and a plurality of fan units 12 configured to raise the airframe 11, which are main components.

The airframe 11 is a structure provided on a lower section of the fan unit 12 and having a transparent canopy 11A, and a battery (not shown) is mounted on a lower section thereof. Further, the transparent canopies 11A may be provided on at least a front surface (a left side of the airframe 11 in FIG. 3), a side surface, and an upper surface in consideration of securing a field of vision when people get into the airframe 11. In addition, when the camera and the sensor are provided, the canopies 11A are provided at positions according to measurement (detection) directions of those.

Further, a loading space for luggage may be provided in the airframe 11 instead of a boarding space for people or together with a boarding space for people.

Each of the fan units 12 has a fan frame 13 supported by the airframe 11, a support arm 14 integrated with the fan frame 13, a propeller 15, a drive motor 16 and a motor driver 17. The propeller 15 is axially supported by the support arm 14 and generates a lifting power and a propulsion power by rotation. The drive motor 16 is driven to rotate the propeller 15. The motor driver 17 controls the drive motor 16.

In addition, the plurality of (in the example, four) fan units 12 are disposed to be point-symmetrical and line-symmetrical to each other (line-symmetrical to a centerline in a forward/rearward direction) when seen in a plan view with respect to the airframe 11.

The fan frame 13 is disposed in a ring shape to surround the propeller 15 from the surroundings thereof. In addition, the fan frame 13 is disposed such that the plurality of fan frames 13 form a planar surface as a whole.

Three support arms 14 are disposed in each of the ring-shaped fan frames 13, and the three support arms 14 are disposed in a radial shape from a frame center part 13A.

In addition, the support arms 14 are disposed at a position above the propeller 15, and provided to support the motor driver 17 at the position above the propeller 15 (to be described below).

The propeller 15 is rotationally supported via a support shaft (not shown) in the upward/downward direction axially supported by the frame center part 13A and the tip portion of the support arm 14.

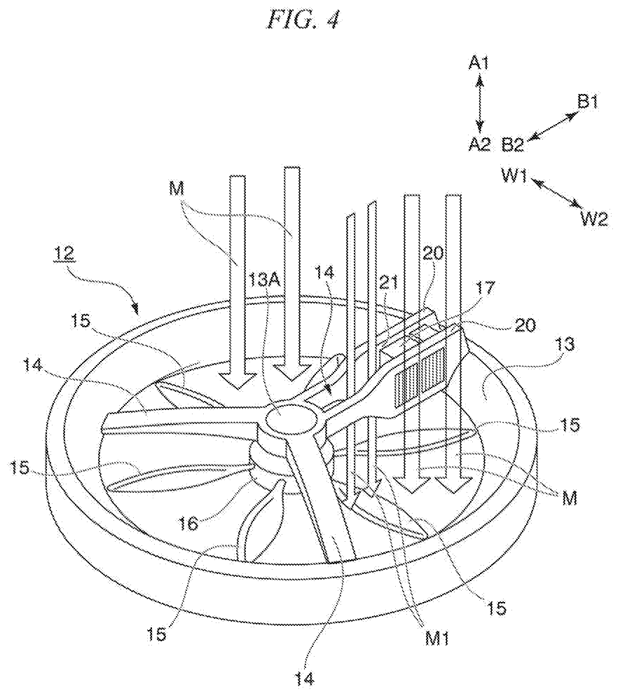

The drive motor 16 is provided on the frame center part 13A and the tip portion of the support arm 14. The drive motor 16 generates a lifting power that is a levitation force on the airframe 11 by rotatably driving the propeller 15 and sending the air from above to below (a flow of the air is shown by arrows M and M1 in FIG. 4).

The motor driver 17 controls a driving current supplied to the drive motor 16, and adjusts rotation of the propeller 15. The motor driver 17 is disposed on one of the three support arms 14 disposed at positions above the propeller 15 in each of the fan frames 13.

The support arm 14 at the place that supports the motor driver 17 will be described with reference to FIG. 3 and FIG. 4.

Each support arm 14 that supports the motor driver 17 has a pair of guide plates 20 configured to guide the air flow suctioned from above the propeller 15 to the motor driver 17.

In the pair of guide plates 20, plate surfaces of the guide plates 20 extend in the upward/downward direction (an arrow A1-A2 direction). The pair of guide plates 20 in the embodiment are disposed parallel to each other in a widthwise direction (an arrow W1-W2 direction) of the airframe 11 perpendicular to the plate surface with a gap 21 therebetween, and the motor driver 17 is installed in the gap 21. Further, the guide plates 20 are disposed to accommodate the motor driver 17 at a predetermined interval therebetween in a planar surface perpendicular (in the embodiment, orthogonal) to a rotational central axis of the propeller 15 in a direction according to an orientation of the support arm 14 with respect to the airframe 11 without being limited to the widthwise direction of the airframe 11.

The support arms 14 having the guide plates 20 are provided at four places in the forward/rearward direction (an arrow B1-B2 direction) of the airframe 11 as shown in FIG. 3 in detail. The support arms 14 having the guide plates 20 are disposed to be point-symmetrical and line-symmetrical (line-symmetrical to a centerline in the forward/rearward direction) when seen in a plan view with respect to the airframe 11. In addition, in the embodiment, the support arms 14 having the guide plates 20 have tips that are disposed to be directed toward a central part of the flight vehicle 101. More specifically, in the support arms 14 having the guide plates 20, the two support arms 14 on the left side in FIG. 3 are disposed such that the tips are directed toward a rear side of the airframe 11 (an arrow B1), and the two support arms 14 on the right side are disposed such that the tips are directed toward a front side of the airframe 11 (an arrow B2).

Then, the support arms 14 integrated with the fan frames 13 of the fan units 12 supported by the airframe 11 are provided in the flight vehicle 101 configured as above, and the support arms 14 are disposed at positions above the propeller 15. In the flight vehicle 101, further, the motor driver 17 which generates a large quantity of heat is disposed in the pair of guide plates 20 of the support arm 14 disposed at a position above the propeller 15.

Accordingly, in the flight vehicle 101, when the air is sent from above toward below by rotational driving of the propeller 15 (the air flow is shown by an arrow M in FIG. 4), some of the air suctioned into the propeller 15 from above is moved along the guide plates 20 as shown by an arrow M1. Accordingly, some of the suctioned air can be blown into the motor driver 17 in the guide plates 20, and cool the motor driver 17. In addition, the drive motor 16 provided coaxially with the propeller 15 can be simultaneously cooled.

As a result, the flight vehicle 101 can be reduced in weight without the need for a dedicated cooling device by cooling the drive motor 16 and the motor driver 17 using the air flow of the propeller 15 that produces an airframe thrust.

In addition, the guide plates 20 are disposed in the forward/rearward direction (an arrow B1-B2 direction) of the airframe 11. For this reason, it is possible to improve straightness of the airframe 11 in the forward/rearward direction and stabilize the flight.

In addition, the guide plates 20, i.e., the motor drivers 17 are disposed from an outer side toward an inner side of the flight vehicle 101 (oriented to approach the airframe 11 disposed at centers of the four fan units 12). Accordingly, it is possible to minimize a length of a power supply feed cable (not shown) that reaches the motor driver 17 from a power supply (battery), which is not shown, mounted on the airframe 11. Accordingly, it is possible to reduce the weight of the power supply feed cable and minimize heat loss due to an internal resistance of the power supply feed cable.

That is, in the flight vehicle 101 of the embodiment, the motor driver 17 can be efficiently cooled by a simple configuration in which the motor driver 17 with a large heat quantity is disposed on the support arm 14 disposed at an upper position that is a suction side of the propeller 15.

Further, the flight vehicle 101 configured as above can be modified and implemented as described below.

### VARIANT EXAMPLE 1

In the embodiment, the motor driver 17 is disposed in the pair of guide plates 20 of the support arm 14. However, a sheet of a guide plate 20 may be provided, and the motor driver 17 may be installed on a wall surface of the guide plate 20.

In addition, in the embodiment, the guide plates 20 provided on the support arm 14 are not limited to a pair and may be three or more plates.

In the embodiment, when seen in a plan view with respect to the airframe 11, four fan units 12 are installed to be point-symmetrical and line-symmetrical (line-symmetrical to a centerline in the forward/rearward direction) to each other. However, the number of the fan units 12 that are installed is not particularly limited.

### VARIANT EXAMPLE 2

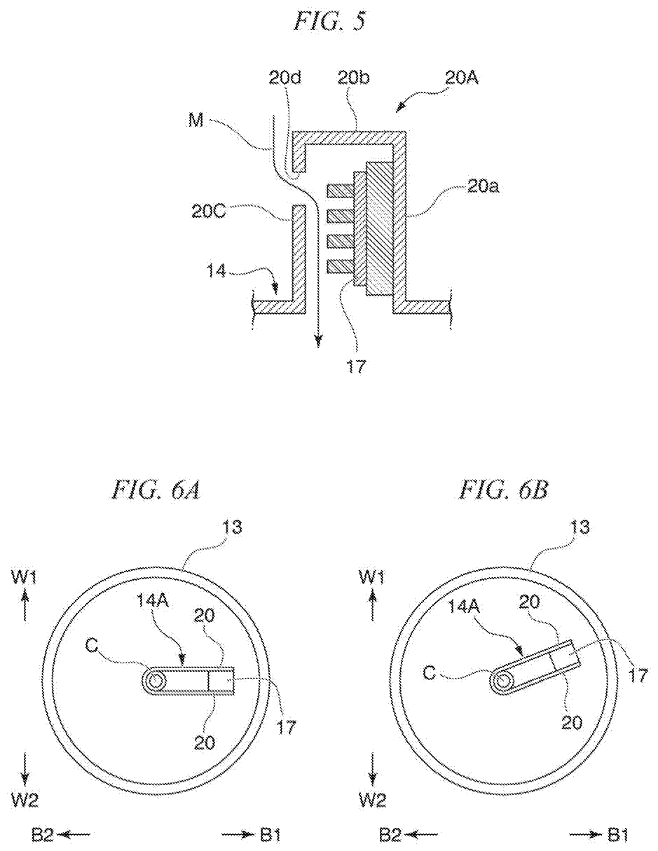

While the guide plates 20 in FIG. 1 to FIG. 4 have a function of guiding the cooling air by simply sandwiching the motor driver 17, instead of this, the structure shown in FIG. 5 may be used. The guide plate 20A of FIG. 5 is configured by providing a side plate 20a, an upper surface plate 20b, and a side plate 20c to surround the motor driver 17. An opening section 20d is formed in the side plate 20c.

According to the configuration, as shown by the arrow M, the air upstream from the propeller can be taken from the opening section 20d to be guided to the motor driver 17. In addition, it is possible to reduce intrusion of rainwater into the motor driver 17, for example, when flying in rainy weather by enclosing the motor driver 17 with the guide plates 20A.

### VARIANT EXAMPLE 3

In the embodiment, while the guide plates 20 are disposed to be fixed to the airframe 11, there is no limitation thereto. As a configuration in which the support arm 14A connected to the guide plates 20 is movable about a central axis C of the drive motor (the propeller) in the upward/downward direction (the arrow A1-A2 direction in FIGS. 3 and 4), the guide plates 20 are directed parallel to the forward/rearward direction (a B1-B2 direction) of the airframe 11 as shown in FIG. 6A, or as shown in FIG. 6B, may be adjusted in a direction inclined with respect to the forward/rearward direction. Accordingly, a function as a rudder configured to swing (yaw) the airframe 11 may be provided.

As mentioned above, several technologies have been proposed in relation to a multi-rotor helicopter and a cooling method in the multi-rotor helicopter.

Incidentally, in a flight vehicle disclosed in Patent Document 1, a duct configured to guide part of an air flow of a propeller to a controller at a center below a support boom is provided in the support boom.

When such a duct is provided in the support boom, there is a problem that the overall structure becomes complicated, the number of man-hours at the time of manufacturing is high, and thus, the weight and manufacturing costs are high.

In addition, while providing a dedicated cooling device in the flight vehicle having such as a large heat quantity is conceivable, in this case there is a new problem that the weight is increased due to installation of the cooling device and effective flight is impossible.

An example advantage according to at least one of the example embodiment is, a motor driver can be efficiently cooled by disposing the motor driver in an air flow entering the propeller.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

An example advantage according to at least one of the example embodiment relates to a multi-rotor helicopter (a flight vehicle) and a cooling method thereof that are capable of transporting an object, people, or the like, by air.

What is claimed is:

1. A multi-rotor helicopter comprising:
an airframe that is a device main body, and a plurality of fan units configured to raise the airframe,
wherein each of the plurality of fan units has a fan frame supported by the airframe, a propeller axially supported by a support arm integrated with the fan frame and configured to generate a lifting power and a propulsion power by rotation, a drive motor driven to rotate the propeller, and a motor driver configured to control a driving current supplied to the drive motor and control rotation of the propeller, and
the propeller of the fan unit is provided at a position below the motor driver.

2. The multi-rotor helicopter according to claim 1, wherein the support arm configured to support the motor driver has guide plates configured to guide an air flow suctioned from above the propeller to the motor driver.

3. The multi-rotor helicopter according to claim 2, wherein the guide plates are disposed parallel to each other with a gap therebetween in a direction along a surface crossing a rotational central axis of the propeller, and the motor driver is disposed in a gap portion indicating this gap.

4. The multi-rotor helicopter according to claim 2, wherein the support arm having the guide plates is disposed in a forward-rearward direction of the airframe.

5. The multi-rotor helicopter according to claim 2, wherein the guide plates are provided swingably about an axis in an upward-downward direction of the support arm.

6. The multi-rotor helicopter according to claim 1, wherein the airframe has a canopy and is provided on a lower section of the fan unit.

7. The multi-rotor helicopter according to claim 2, wherein the plurality of fan units are disposed to be symmetrical to each other when seen in a plan view with respect to the airframe, and disposed such that the guide plates of the support arms provided in the plurality of fan units are symmetrical to each other when seen in a plan view with respect to the airframe.

8. The multi-rotor helicopter according to claim 7, wherein the guide plates are disposed in a direction approaching a center of the plurality of fan units from a rotational central axis.

9. A cooling method of a multi-rotor helicopter in a flight vehicle comprising an airframe that is a device main body, and a plurality of fan units configured to raise the airframe,
wherein each of the plurality of fan units has a fan frame supported by the airframe, a propeller supported by a support arm integrated with the fan frame and configured to generate a lifting power and a propulsion power by rotation, a drive motor driven to rotate the propeller, and a motor driver configured to control a driving current supplied to the drive motor and control rotation of the propeller, and
the method comprising: providing the support arm at a position above the propeller that becomes a suction side of the propeller, and supporting the motor driver using the support arm at the position thereabove.
